(19) United States
(12) Patent Application Publication
(10) Pub. No.: US 2004/0240553 A1
(43) Pub. Date: Dec. 2, 2004

(54) Motion vector detecting method and image processing appparatus using the same

(75) Inventors: Yuichiro Kurihara, Fukuoka (JP); Hideaki Fukuda, Fukuoka (JP); Kenichi Tsunoji, Fukuoka (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation

(21) Appl. No.: 10/839,480

(22) Filed: May 5, 2004

(30) Foreign Application Priority Data
May 26, 2003 (JP) P2003-148339

(51) Int. Cl. H04N 7/12

(52) U.S. Cl. 375/240.16; 348/699; 375/240.24

(57) ABSTRACT

Both a data transfer process and a difference data detection process is executed in parallel. The data transfer process extracts a plurality of current image macro block data from a first internal memory storing image data of a current image and makes an internal memory controller sequentially transfer the current image macro block data into a second internal memory. The difference data detection process makes a processor core section sequentially detect difference data between the current image macro block data sequentially transferred to the second internal memory and the reference image macro block data stored in the second internal memory. It is possible to shorten greatly a process time of an image processing apparatus.

### CROSS REFERENCE TO RELATED APPLICATION

The present document is based on Japanese Priority Document JP2003-148339, filed in the Japanese Patent Office on May 26, 2003, the entire contents of which being incorporated herein by reference.

### BACKGROUND OF THE INVENTION

1. Field of the Invention

The present invention relates to a motion vector detecting method and a motion vector detecting apparatus using the method.

2. Description of Related Art

H. 261 standards proposed by Moving Picture Experts Group (MPEG) are widely adopted as methods of compressing and encoding a large amount of moving image data in the related art.

According to the H. 261 standards, encoding is performed for each macro block data constituted of a predetermined number of pixels of continuous image data. For this encoding, a motion vector is detected which is representative of a displacement between the macro block data of a reference image and the macro block data of a current image, the current image being made of image data to be encoded and the reference image being made of image data immediately before the current image (e.g., refer to Japanese Patent Application Publication No. HEI-10-42300).

An image processing apparatus 101 such as shown in FIG. 9 has been used for detecting a motion vector. As shown, in the image processing apparatus 101, a processor 102 is connected to external memories 104 and input/output devices 105 via an external data bus 103, and a processor core section 106 inside the processor 102 is connected to internal memories 108 via an internal data bus 107.

The image processing apparatus 101 detects a motion vector in the following manner.

The processor core section 106 transfers the macro block data of a reference image from the external memory 104 to the internal memory 108 via the external data bus 103.

Next, the processor core section 106 transfers the macro block data of a current image from the external memory 104 to the internal memory 108 via the external data bus 103.

The processor core section 106 detects difference data between the macro block data of the current image and the macro block data of the reference image respectively stored in the internal memory 108, and stores the difference data in the internal memory 108.

The processor 106 transfers the macro block data of a current image, which is obtained by shifting the macro block data at the preceding stage by one pixel line, from the external memory 104 to the internal memory 108 via the external data bus 103.

The processor section 106 detects difference data between the macro block data of the current image and the macro block data of the reference image respectively stored in the internal memory 108, and stores the difference data in the internal memory 108.

The processor core section 106 repeats transferring sequentially the macro block data of the current image shifted by one pixel line and detecting the difference data, for all macro block data, and finally detects as a motion vector the displacement between the macro block data of a reference image and the macro block data of a current image having smallest difference data.

In the image processing apparatus of the related art described above, the processor core section 106 sequentially executes the macro block data transfer process and the difference data detection process. It is therefore impossible to detect the difference data during the macro block data transfer process, and it takes a fairly long time to detect a motion vector.

If it takes a long time to detect a motion vector, it arises the fear that a real time process of inputting and encoding image data becomes impossible when a large amount of moving image data is used in order to realize high image quality.

In one embodiment of the present invention, a method of detecting a motion vector between macro block data of a current image and macro block data of a reference image is provided, which includes the steps of: executing both a data transfer process and a difference data detection process in parallel, the data transfer process extracting a plurality of current image macro block data from a first internal memory storing image data of a current image and making an internal memory controller sequentially transfer the current image macro block data into a second internal memory, and the difference data detection process making a processor core section sequentially detect difference data between the current image macro block data sequentially transferred to the second internal memory and the reference image macro block data stored in the second internal memory; and thereafter making the processor core section detect as a motion vector a displacement between the reference image macro block data and the current image macro block data having a smallest difference data.

In another embodiment of the present invention, an image processing apparatus for detecting a motion vector between macro block data of a current image and macro block data of a reference image is provided, which includes first and second internal memories connected to a processor core section via an internal bus; an internal memory controller disposed outside the processor core section for controlling data transfer between the first and second internal memories, wherein: while a data transfer process is executed by the internal memory controller, a difference data detection process is executed by the processor core section to execute both the data transfer process by the internal memory controller and the difference data detection process by the processor core section in parallel, the data transfer process extracting a plurality of current image macro block data from the first internal memory storing image data of a current image and making the internal memory controller sequentially transfer the current image macro block data into the second internal memory, and the difference data detection process making the processor core section sequentially detect difference data between the current image macro block data sequentially transferred to the second internal memory and the reference image macro block data stored in the second internal memory; and thereafter the processor core section detects as a motion vector a displacement between the reference image macro block data and the current image macro block data having a smallest difference data.

In still another embodiment of the present invention, a configuration that the internal memory controller is connected to the processor core section via the internal data bus is provided.

Since the data transfer process and the difference data detection process are executed in parallel, the difference data may be detected during the data transfer process. It is therefore possible to shorten the time taken to detect a motion vector and to process both image data input and encoding in real time even if a large amount of moving image data is used in order to realize high image quality.

If the processor core section is connected to the internal memory controller via the internal data bus, a control signal supplied from the processor core section can be transmitted quickly to the internal memory controller by using the internal data bus. In this case, a process time of the image processing apparatus can be shortened further.

### BRIEF DESCRIPTION OF THE DRAWINGS

FIG. 1 is an illustrative diagram showing an image processing apparatus according to the invention;

FIG. 2 is an illustrative diagram showing an internal memory controller;

FIG. 3 is an illustrative diagram showing a transfer source memory space;

FIG. 4 is an illustrative diagram showing a data path;

FIG. 5 is an illustrative diagram showing an address generator;

FIG. 6 is an illustrative diagram showing a motion vector detection method;

FIG. 7 is an illustrative diagram showing a current image;

FIG. 8 is an illustrative diagram showing a reference image; and

FIG. 9 is an illustrative diagram showing an image processing apparatus of the related art.

### DESCRIPTION OF THE PREFERRED EMBODIMENT

In an image processing apparatus of the present invention, a first and second internal memories and an internal memory controller are connected to a processor core section via an internal data bus. The first and second internal memories each have dual ports. One port of the internal memory is connected to the processor core section via the internal data bus, and the other port is connected to the internal memory controller.

In the image processing apparatus, a plurality of external memories is connected to the processor core section via an external data bus, a plurality of input/output devices is connected to the processor core section via a request signal line, and the internal memory controller is also connected to the external memories and input/output devices.

In the image processing apparatus, the internal memory controller is disposed outside the processor core section, the internal memory controller controlling data transfer to the internal memory connected to the processor core section via the internal data bus.

With these arrangements, the data transfer process to the internal memory and the process by the processor core section can be executed in parallel, so that the process time of the image processing apparatus can be shortened considerably.

Since the internal memory controller is disposed outside the processor core section, the internal memory controller is not necessary to be changed even if the specification of the processor core section is altered, resulting in a shortened time taken to develop an image processing apparatus.

In the image processing apparatus, since the internal memories, external memories and input/output devices are connected to the internal memory controller, data transfer is possible between the internal memories, between the internal memory and external memory and between the internal memory and input/output device, in parallel to and independently from the process by the processor core section.

Further, since the processor core section and internal memory controller are connected via the internal data bus, a control signal supplied from the processor core section can be transmitted quickly to the internal memory controller. For that reason, the process time of the image processing apparatus can be shortened further.

Furthermore, since the internal memory controller and input/output device are connected via the request signal line, data transfer by the internal memory controller can be started by using a request signal from the input/output device. Still further, since after the data transfer by the internal memory controller, a request signal can be sent back to the input/output device, and the data transfer process can be started and terminated quickly without involvement of the processor core section, resulting in a reduced load of the processor core section.

In the present invention, a motion vector is detected in the following manner.

First, image data in a predetermined search range is extracted from image data of a current image stored in the external memory, and transferred to the first internal memory.

Macro block data is extracted from image data of a reference image stored in the external memory, and transferred to the second internal memory.

Next, the internal memory controller executes a data transfer process of extracting a plurality of macro block data from the image data of the current image stored in the first internal memory, and sequentially transferring the macro block data to the second internal memory.

Next, the processor core section executes a difference data detection process of sequentially detecting difference data between the current image macro block data sequentially transferred to the second internal memory and the reference image macro block data stored in the second internal memory. The difference data is stored in the second internal memory.

In this manner, the data transfer process by the internal memory controller and the difference data detection process by the processor core section are executed in parallel.

Thereafter, the processor core section detects as a motion vector a displacement between the reference image macro block data and the current image macro block data having the smallest difference data.

In the above manner, when the motion vector is to be detected, the data transfer process by the internal memory controller is performed in parallel to the difference data detection process by the processor core section so that the difference data can be detected during the data transfer process. It is therefore possible to shorten the time taken to detect a motion vector and to process both image data input and encoding in real time even if a large amount of moving image data is used in order to realize high image quality.

With reference to the accompanying drawings, description will be made on a specific embodiment of an image processing apparatus for detecting a motion vector according to the invention.

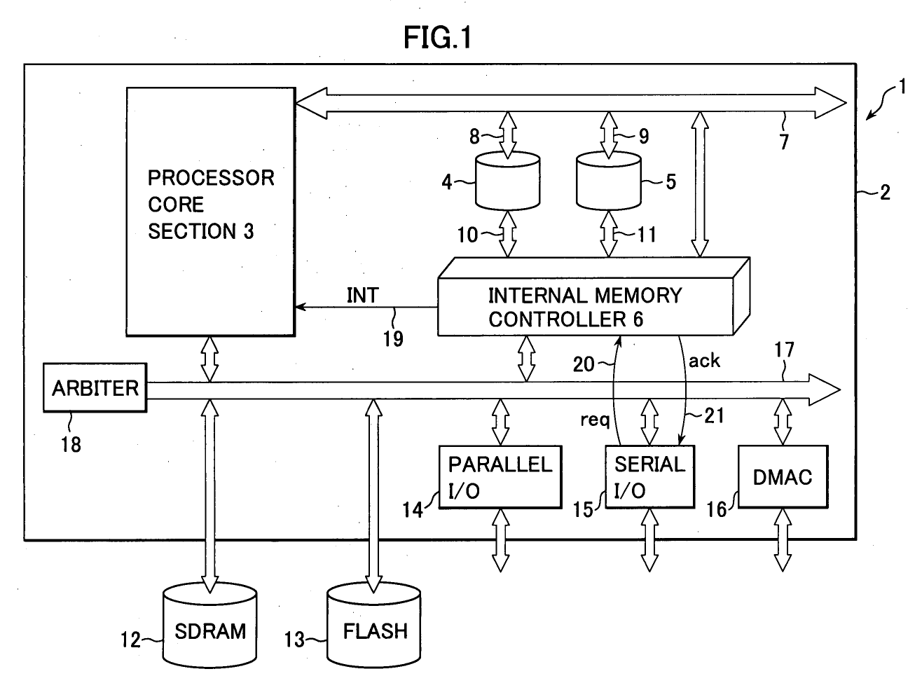

As shown in FIG. 1, an image processing apparatus 1 according to the invention has a processor 2 having therein a processor core section 3 for executing various arithmetic operations. The processor core section 3 is connected to two dual-port internal memories 4 and 5 and an internal memory controller 6 via an internal data bus 7. The internal memory controller 6 controls data transfer to and from the internal memories 4 and 5. The internal memories 4 and 5 are also connected directly to the internal memory controller 6. The internal memories 4 and 5 each have dual ports. Ones of input/output ports 8 and 9 are connected to the processor core section 3 via the internal data bus 7, and other input/output ports 10 and 11 are connected to the internal memory controller 6.

The image processing apparatus 1 connects external memories 12 and 13, input/output devices 14 and 15 and a direct memory access controller 16 via an external data bus 17. Reference numeral 18 represents an arbiter for regulating user requests for the external data bus 17.

The image processing apparatus 1 also connects the processor core section 3 and internal memory controller 6 via the external data bus 17. The internal memory controller 6 can transmit an interrupt signal to the processor core section 3 via an interrupt signal line 19, and can transmit/receive a request signal to/from the input/output device 15 via request signal lines 20 and 21.

In the image processing apparatus 1, the internal memory controller 6 disposed outside the processor core section 3 controls data transfer between the internal memories 4 and 5, between the internal memory 4, 5 and external memory 12, 13 and between the internal memory 4, 5 and input/output device 14, 15, in parallel to and independently from the process under execution by the processor core section 3.

The configuration of the internal memory controller 6 will be described hereinunder.

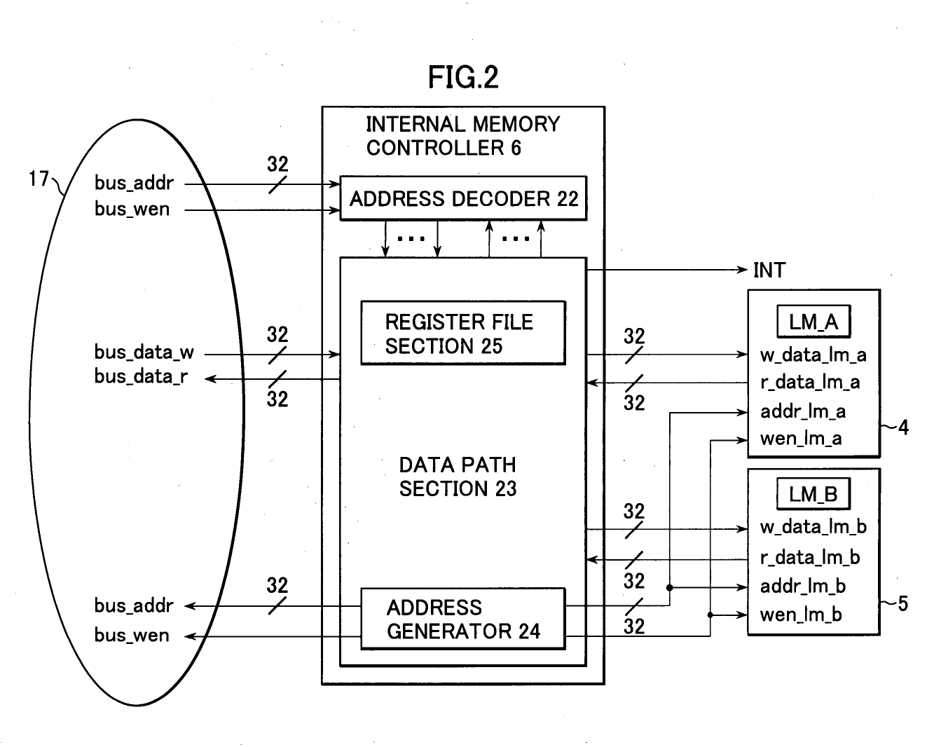

As shown in FIG. 2, the internal memory controller 6 is constituted of an address decoder 22, a data path section 23 and an address generator 24.

The internal memory controller 6 is mapped to a memory space of the processor 2. This memory map is shown in Table 1. Each mapped register is implemented in a register file section 25 provided in the data path section 23.

TABLE 1

| Memory | | | | | |
|---|---|---|---|---|---|
| Space | Register | | | | Initial |
| Address | Name | Bit | R/W | Function | Value |
| ABCD_0000h | SADDR | 32 | R/W | Transfer | “X” |
| | | | | Source | |
| | | | | Address | |
| ABCD_0004h | DADDR | 32 | R/W | Transfer | “X” |
| | | | | Destination | |
| | | | | Address | |
| ABCD_0008h | BSIZE | 32 | R/W | Rectangle | “X” |
| | | | | Transfer | |
| | | | | Block | |
| | | | | Lateral | |
| | | | | Size | |
| ABCD_000Ch | BOFFSET | 32 | R/W | Rectangle | “X” |
| | | | | Transfer | |
| | | | | Block | |
| | | | | Lateral | |
| | | | | Offset | |
| ABCD_0010h | CNTRL | 32 | R/W | Control | “0” |
| | | | | Register | |
| ABCD_0014h | START | 32 | W | Transfer | “X” |
| | | | | Start | |
| | | | | Register | |
| ABCD_0018h | INTREQ | 32 | R/W | Transfer | “0” |
| | | | | Completion | |
| | | | | Notice | |
| | | | | Interrupt | |
| | | | | Request | |

The address decoder 22 decodes an address supplied from an address bus (bus_addr) of the external data bus 17, in accordance with the memory map shown in Table 1.

The function of each register shown in Table 1 will be described.

A register SADDR indicates an address of a transfer source of data transfer, and stores addresses of transfer sources including the internal memories 4 and 5, external memories 12 and 13 and input/output devices 14 and 15.

A register DADDR indicates an address of a transfer destination of data transfer, and stores addresses of transfer destinations including the internal memories 4 and 5, external memories 12 and 13 and input/output devices 14 and 15.

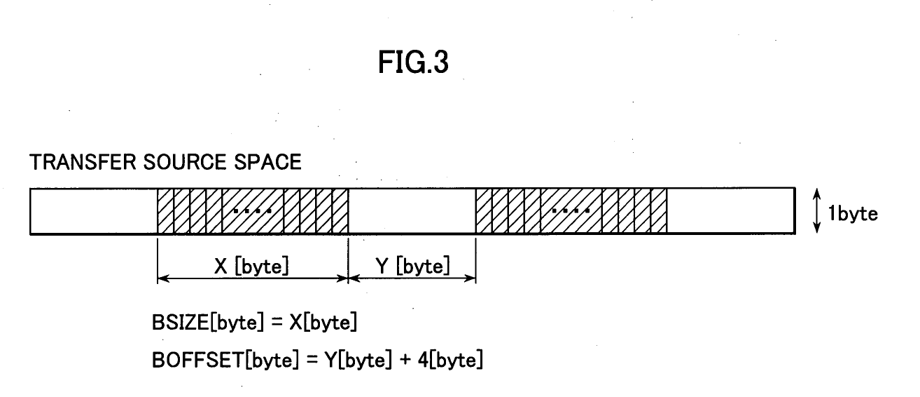

Registers BSIZE and BOFFSET are used for transfer of discontinuous data, and as shown in FIG. 3 are used when block data having a size of bytes designated by the register BSIZE is sequentially transferred with a blank space of bytes designated by the register BOFFSET between block data.

A register CNTRL is constituted of control flags for data transfer, the flags being shown in Table 2.

TABLE 2

| | | | | Initial |
|---|---|---|---|---|
| Flag Name | Range | R/W | Function | Value |
| STATUS | [31] | R | Operation | 0: DURING |
| | | | Status | STOP |
| | | | Display (only | |
| | | | read) | |
| | | | 0: DURING STOP | |
| | | | (ACKNOWLEDGE) | |
| | | | 1: DURING DATA | |
| | | | TRANSFER | |
| BGM_EN | [30] | R/W | Transfer | 0: MASK |
| | | | Request | |
| | | | Signal | |
| | | | Enable | |
| | | | 0: MASK | |
| | | | 1: PERMIT | |
| INT_EN | [29] | R/W | Transfer | 0: MASK |
| | | | Completion | |
| | | | Notice | |
| | | | Interrupt | |
| | | | Signal Enable | |
| | | | 0: MASK | |
| | | | 1: PERMIT | |
| SADDR_INIT | [28] | R/W | Transfer | 0: NO |
| | | | Source | RETURN |
| | | | Addresses | |
| | | | After | |
| | | | Transfer | |
| | | | Completion | |
| | | | 0: NO RETURN TO | |
| | | | INITIAL VALUE | |
| | | | 1: RETURN TO | |
| | | | INITIAL VALUE | |
| DADDR_INIT | [27] | R/W | Address After | 0: NO |
| | | | Transfer | RETURN |
| | | | 0: NO RETURN TO | |
| | | | INITIAL VALUE | |
| | | | 1: RETURN TO | |
| | | | INITIAL VALUE | |
| SADDR_ADD | [26] | R/W | Transfer | 0: UPDATE |
| | | | Source | |
| | | | Address | |
| | | | Update | |
| | | | 0: UPDATE | |
| | | | 1: NO UPDATE | |
| DADDR_ADD | [25] | R/W | Transfer | 0: UPDATE |
| | | | Destination | |
| | | | Address | |
| | | | Update | |
| | | | 0: UPDATE | |
| | | | 1: NO UPDATE | |
| BLOCK_EN | [24] | R/W | Rectangle | 0: NOP |
| | | | Transfer | |
| | | | 0: NOP | |
| | | | 1: OP | |
| BURST_LEN | [23:0] | R/W | Transfer | “0” |
| | | | Burst Length | |
| | | | (Byte | |
| | | | Designate) | |

A register START indicates a start of data transfer. Data transfer starts when arbitrary data is written in this register START.

A register INTREQ notifies data transfer completion by an interrupt signal (refer to Table 3). Normally, this register INTREQ is set to “1” after data transfer completion and reset to “0” in an interrupt routine.

TABLE 3

| Register | | | | Initial |
|---|---|---|---|---|
| Name | Range | R/W | Function | Value |
| | [31:1] | R/W | Don't Care | “0” |
| | [0] | R/W | Transfer | 0: NOP |
| | | | Completion | |
| | | | Notice | |
| | | | Interrupt | |
| | | | Signal | |
| | | | 0: NOP | |
| | | | 1: INTERRUPT | |
| | | | REQUEST | |

The address decoder 22 decodes an address supplied from an address bus (bus_addr) of the external data bus 17, in accordance with the memory map shown in Table 1, and the data path section 23 operates to store data supplied from data bus (bus_data_r) of the external data bus 17 in a corresponding register.

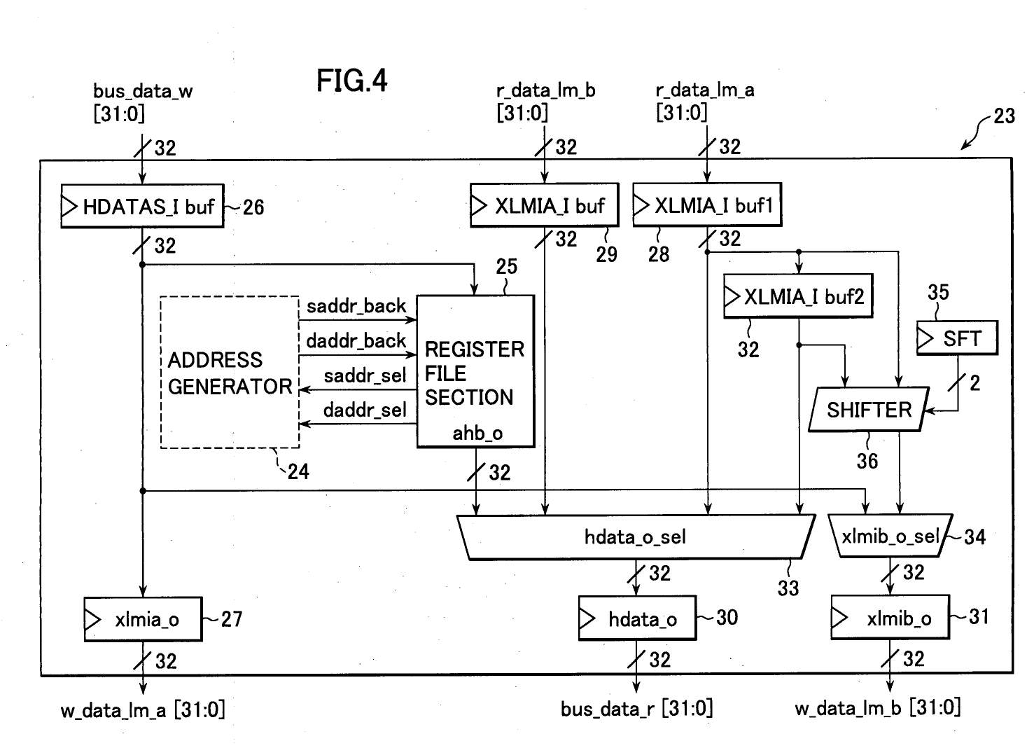

The data path section 23 has the configuration shown in the block diagram of FIG. 4. The data path section 23 includes seven paths in total: two-way paths between the external data bus 17 and internal memory 4; two-way paths between the external data bus 17 and internal memory 5; one-way path from the internal memory 4 to internal memory 5; and two-way paths between the external data bus 17 and register file section 25 (refer to FIG. 4).

TABLE 4

| | | From Signal | |
|---|---|---|---|
| From | To | Name | To Signal Name |
| System Bus | LM_A | bus_data_w | w_data_lm_a |
| | LM_B | | w_data_lm_b |
| | Regiter File | | Register File |
| | Section | | Section |
| LM_A | System Bus | r_data_lm_a | bus_data_r |
| | LM_B | | w_data_lm_b |
| LM_B | System Bus | r_data_lm_b | bus_data_r |
| Register File | | Register File | |
| Section | | Section | |

The data path section 23 controls buffers 26 to 32 and selectors 33 and 34 in accordance with the contents of each register in the register file section 25, to establish one path by selecting from the seven paths.

More specifically, when the path from the external data bus 17 to the internal memory 4 is to be established, data from a data bus (bus_data_w) of the external data bus 17 is output to an input port (w_data_lm_a) of the internal memory 4 via the buffer 26 and buffer 27.

When the path from the external data bus 17 to the internal memory 5 is to be established, data from the data bus (bus_data_w) of the external data bus 17 is output to an input port (w_data_lm_b) of the internal memory 5 via the buffer 26, selector 34 and buffer 31.

When the path from the external data bus 17 to the register file section 25 is to be established, data from the data bus (bus_data_w) of the external data bus 17 is input to the register file section 25 via the buffer 26.

When the path from the internal memory 4 to external the data bus 17 is to be established, data from an output port (r_data_lm -a) of the internal memory 4 is output to a data bus (bus_data_r) of the external data bus 17 via the buffer 28, selector 33 and buffer 30.

When the path from the internal memory 4 to the internal memory 5 is to be established, data from the output port (r_data_lm_a) of the internal memory 4 is output to the input port (w_data_lm_b) of the internal memory 5 via the buffer 28, buffer 32, a shifter 36, selector 34 and buffer 31. A buffer 35 and shifter 36 are used for a shift operation, if necessary, during data transfer between the internal memories 4 and 5. Not only a shift operation, but also an addition operation and a subtraction operation may be realized. By forming various arithmetic operation units in the paths, various arithmetic operations can be performed during data transfer.

When the path from the internal memory 5 to the external data bus 17 is to be established, data from an output port (r_data_lm_b) of the internal memory 5 is output to the data bus (bus_data_r) of the external data bus 17 via the buffer 29, selector 33 and buffer 30.

When the path from the register file section 25 to the external data bus 17 is to be established, data from an output port (ahb_o) of the register file section 25 is output to the data bus (bus_data_r) of the external data bus 17 via the selector 33 and buffer 30.

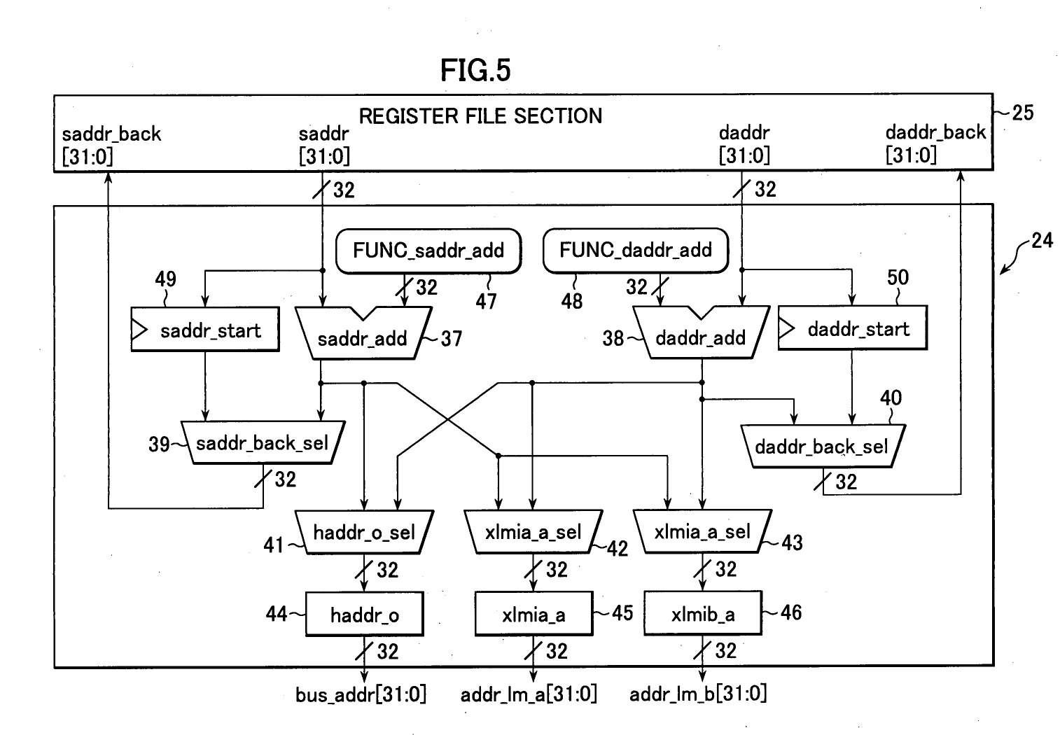

The address generator 24 has the configuration shown in the block diagram of FIG. 5. The address generator 24 generates an address of a transfer source or destination by controlling adders 37 and 38, selectors 39 to 43, buffers 44 to 46 and function operation units 47 and 48 in accordance with the contents of the register SADDR indicating a transfer source address, register DADDR indicating a transfer destination address and control register CNTRL respectively stored in the register file section 25.

The truth table of the function operation unit 47 is shown in Table 5. The function operation unit 47 outputs “4” if a SADDR_ADD flag of the control register CNTRL is “0”, “4” being added at the adder 37 to advance the transfer source address by 4 bytes. If the SADDR_ADD flag of the control register CNTRL is “1”, then “0” is output so as not to renew the transfer source address.

TABLE 5

| CNTRL.SADDR_ADD | FUNC_saddr_add |
|---|---|
| 0 | 4 |
| 1 | 0 |

The truth table of the function operation unit 48 is shown in Table 6. The function operation unit 48 outputs “4” if a DADDR_ADD flag of the control register CNTRL is “0”, “4” being added at the adder 38 to advance the transfer destination address by 4 bytes. If the DADDR_ADD flag of the control register CNTRL is “1”, then “0” is output so as not to renew the transfer destination address.

TABLE 6

| CNTRL.DADDR_ADD | FUNC_daddr_add |
|---|---|
| 0 | 4 |
| 1 | 0 |

The address generator 24 has registers 49 and 50, the register 49 storing an address of a transfer source at the start of data transfer and the register 50 storing an address of a transfer destination at the start of data transfer. After the data transfer, the addresses at the data transfer start are returned back to the register SADDR and register DADDR in the register file section 25.

The address generator 24 outputs an address via the selector 41 and buffer 44 when data is to be transferred to the external data bus 17, outputs an address via the selector 42 and buffer 45 when data is to be transferred to the internal memory 4, and outputs an address via the selector 43 and buffer 46 when data is to be transferred to the internal memory 5.

The image processing apparatus 1 constructed as above transfers data in the manner described hereinunder.

First, a path is established from the external data bus 17 to register file section 25, and the processor core section 3 sets a transfer source address and transfer destination address in respective registers in the register file section 25.

Next, arbitrary data is written from the processor core section 3 in the transfer start register START in the register file section 25.

The internal memory controller 6 transfers data at the transfer source address to the transfer destination address independently from the process under execution by the processor core section 3. In this case, the address generator 24 of the internal memory controller 6 generates addresses of the transfer source and destination, and the data path section 23 establishes a necessary path.

After the data transfer is completed, an interrupt signal is sent to the processor core section 3 via the interrupt signal line 19.

In the above description, the external data bus 17 is used for transferring data from the processor core section 3 to the register file section 25. Instead of the external data bus 17, the internal data bus 7 maybe used if the processor core section 3 and internal memory controller 6 are connected together by the internal data bus 7.

If the data transfer destination is the input/output device 15, data may be written directly in the transfer start register START in the register file section 25 via the request signal line 20 to start data transfer. Thereafter, an acknowledge signal is sent to the input/output device 15 via the request -signal line 21 in place of the interrupt signal line 19.

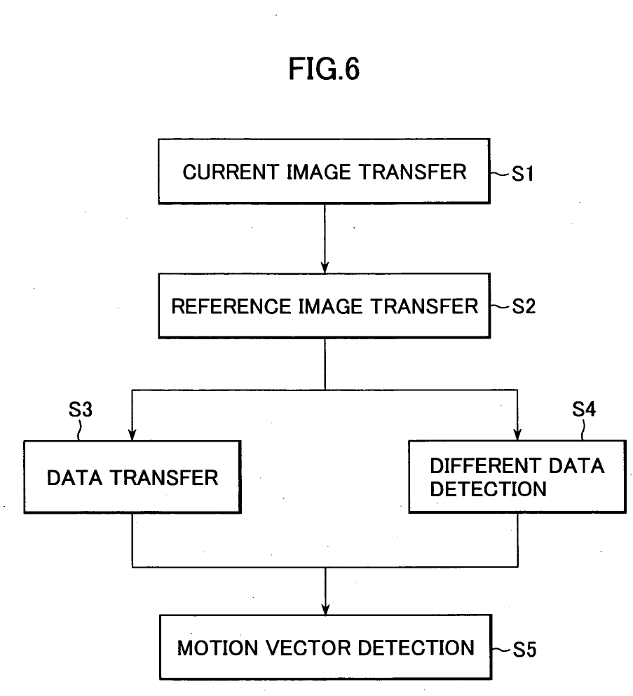

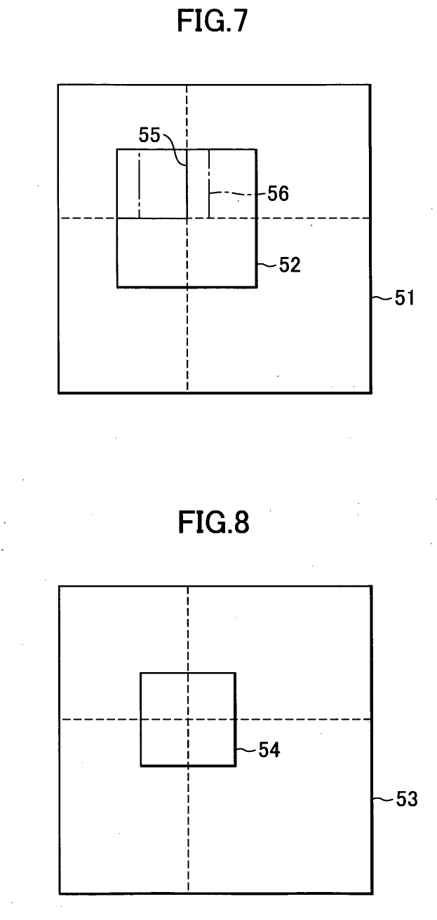

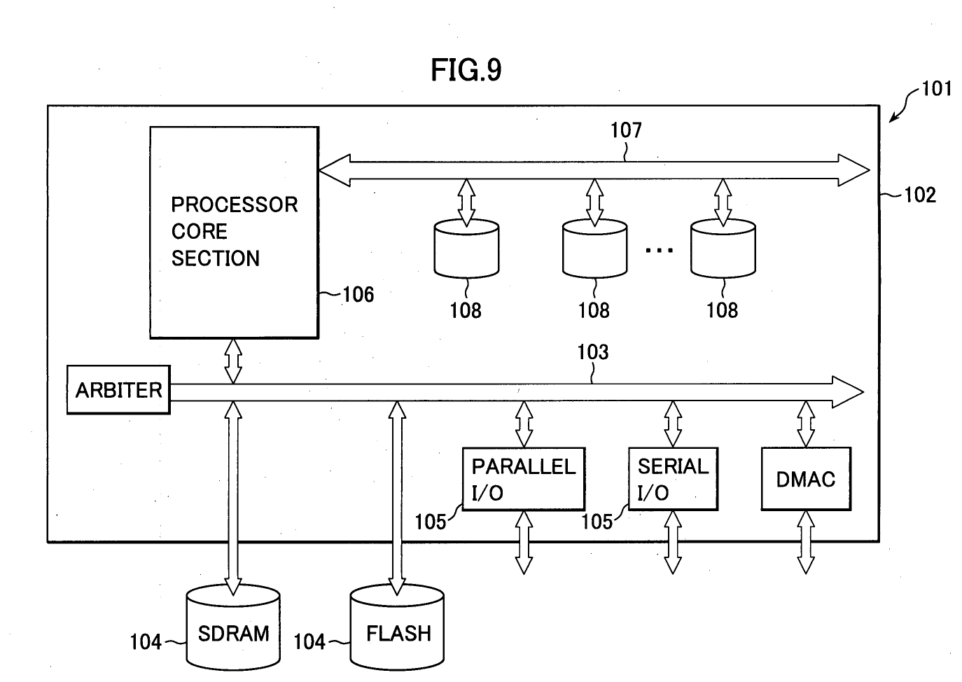

First, the image processing apparatus 1 of this embodiment constructed as above detects a motion vector in the manner described hereinunder (refer to FIGS. 6 to 8).

Image data 52 in a predetermined search range (16 pixels×16 pixels) is extracted from image data 51 of a current image stored in the external memory 12, and transferred to the first internal memory 4 (current image transfer process S1).

Macro block data 54 having a predetermined size (8 pixels×8 pixels) and the same center coordinates as those of the image data 52 is extracted from image data 53 of a reference image stored in the external memory 12, and transferred to the second internal memory 5 (reference image transfer process S2).

Next, a plurality of macro block data 55, 56 are extracted from the image data 52 of the current image stored in the first internal memory 4 by shifting the macro block data by one pixel line in a vertical or horizontal directions, and are sequentially transferred to the second internal memory 5 (data transfer process S3) This data transfer process is performed by the internal memory controller 6. In this case, since the macro block data of 8 pixels×8 pixels is extracted from the search range of 16 pixels×16 pixels by shifting the macro block data by one pixel line. in the vertical and horizontal directions, the number of macro block data 55, 56 is sixty four in total.

Next, differences between corresponding pixel data in the current image macro block data 55, 56 sequentially transferred to the second internal memory 6 and in the reference image macro block data 54 stored in the second internal memory 6 are summed up to obtain difference data which is sequentially detected (difference data detection process S4). This difference data detection process is performed by the processor core section 3. Sixty four detected difference data are stored in the second internal memory 5.

In the image processing apparatus 1, since data transfer can be performed by the internal memory controller 6 independently from the process under execution by the processor core section 3, the data transfer process by the internal memory controller 6 can be performed in parallel to the difference data detection process by the processor core section 3.

Lastly, the processor core section 3 detects as a motion vector a displacement (difference between coordinates) between the reference image macro block data 54 and the current image macro block data 55 (56) having the smallest difference data among sixty four difference data (motion vector detection process S5). This motion vector is used for encoding a moving image in conformity with the H.261 standards of MPEG.

As above, when the motion vector is to be detected, the data transfer process by the internal memory controller 6 is performed in parallel to the difference data detection process by the processor core section 3 so that the difference data can be detected during the data transfer process. It is therefore possible to shorten the time taken to detect a motion vector and to process both image data input and encoding in real time even if a large amount of moving image data is used in order to realize high image quality.

Finally, the embodiments and examples described above are only examples of the present invention. It should be noted that the present invention is not restricted only to such embodiments and examples, and various modifications, combinations and sub-combinations in accordance with its design or the like may be made without departing from the scope of the present invention.

What is claimed is:

1. A method of detecting a motion vector between macro block data of a current image and macro block data of a reference image, comprising the steps of:
executing both a data transfer process and a difference data detection process in parallel, said data transfer process extracting a plurality of current image macro block data from a first internal memory storing image data of a current image and making an internal memory controller sequentially transfer said current image macro block data into a second internal memory, and said difference data detection process making a processor core section sequentially detect difference data between said current image macro block data sequentially transferred to said second internal memory and said reference image macro block data stored in said second internal memory; and
making said processor core section detect as a motion vector a displacement between said reference image macro block data and said current image macro block data having a smallest difference data.

2. An image processing apparatus for detecting a motion vector between macro block data of a current image and macro block data of a reference image, comprising:
first and second internal memories connected to a processor core section via an internal bus;
an internal memory controller disposed outside said processor core section for controlling data transfer between said first and second internal memories,
wherein:
while a data transfer process is executed by said internal memory controller, a difference data detection process is executed by said processor core section to execute both said data transfer process by said internal memory controller and said difference data detection process by said processor core section in parallel, said data transfer process extracting a plurality of current image macro block data from said first internal memory storing image data of a current image and making said internal memory controller sequentially transfer said current image macro block data into said second internal memory, and said difference data detection process making said processor core section sequentially detect difference data between said current image macro block data sequentially transferred to said second internal memory and said reference image macro block data stored in said second internal memory; and
said processor core section detects as a motion vector a displacement between said reference image macro block data and said current image macro block data having a smallest difference data.

3. The image processing apparatus according to claim 2, wherein said internal memory controller is connected to said processor core section via said internal data bus.
